(19) United States
(12) Patent Application Publication
(10) Pub. No.: US 2026/0169139 A1
(43) Pub. Date: Jun. 18, 2026

(54) PROTECTION UNIT AND DETECTION ASSEMBLY FOR A MOTOR VEHICLE

(71) Applicant: VALEO SYSTEMES D'ESSUYAGE, La Verriere (FR)

(72) Inventors: Alexandre FILLOUX, La Verriere (FR); Frederic GIRAUD, La Verriere (FR); Frederic BRETAGNOL, La Verriere (FR)

(73) Assignee: VALEO SYSTEMES D'ESSUYAGE, La Verriere (FR)

(21) Appl. No.: 19/119,807

(22) PCT Filed: Oct. 12, 2023
(86) PCT No.: PCT/EP2023/078336

§ 371 Date: Apr. 10, 2025

(30) Foreign Application Priority Data
Oct. 12, 2022 (FR) FR2210484

(51) Int. Cl. G01S 7/497; G01S 17/931

(52) U.S. Cl. CPC G01S 7/497; G01S 17/931; G01S 2007/4977

(57) ABSTRACT

The invention relates to a protection unit for an apparatus and to a detection assembly associating the apparatus emitting or capturing radiation through a region of interest of an optical surface of the protection unit. The protection unit further includes at least one wave transducer configured to generate an acoustic wave on or in the optical surface in order to clean the optical region of interest. According to the invention, the protection unit further includes an openwork surface located facing the optical surface, the openwork surface includes a solid portion and at least one opening through which the radiation emitted and/or captured by the apparatus can pass.

### TECHNICAL FIELD

The technical context of the present invention is that of sensors, and in particular of devices for cleaning an optical surface through which surface said sensors carry out their measurements. More particularly, the invention relates to a protecting unit allowing such cleaning to be carried out, to a detecting assembly comprising such a protecting unit and to a motor vehicle.

### BACKGROUND OF THE INVENTION

Generally, the present invention relates to a protecting unit employing a wave transducer allowing bodies making contact with the optical surface to be cleaned off, by means of ultrasonic waves. By “clean”, what is meant here is that the wave transducer is configured to remove bodies that were present in contact with the optical surface so that, after the cleaning operation, the optical surface is free from said bodies.

The present invention has applications in numerous fields. By way of non-limiting example, an objective sought by the present invention is to eliminate effects associated with the accumulation of bodies on an optical surface, such as, in particular, raindrops, frost or snow.

In order to remove these bodies from a surface, when they are in the liquid state and present in the form of drops on the optical surface, it is known to rotate said drops in order to be able to remove them from the surface. A known drawback of this technique is that it is unsuitable for surfaces the area of which is larger than a few square centimeters.

Use of an electrical field to control the hydrophobicity of a surface is also known, as described for example in KR 2018 0086173 A1. This technique, which is known by the acronym EWOD meaning “Electro Wetting On Devices”, consists of applying a potential difference between two electrodes, so as to electrically bias the surface from which it is wished to remove the drops of liquid, and for the purpose of modifying the wetting properties thereof. By controlling the location of the bias, the drop may then be moved. One known disadvantage of this technique is that it may be implemented only with particular materials, and requires particularly precise positioning of the electrodes over the entire area where it is wished to control wetting properties, making its industrialization, its mass production, and its incorporation into products intended for the automobile industry for example, complex or problematic.

Furthermore, use of a windshield wiper on a windshield of a motor vehicle is of course also known. However, this proven technique has the disadvantage of obstructing a field of view accessible to the driver. Furthermore, each time the windshield wiper passes it spreads fatty particles deposited on the surface of the windshield. In addition, it is necessary to regularly replace the fittings of the windshield wiper, which become worn during their use. Lastly, this technique cannot be used, or may be used only with difficulty, to clean sensors used on motor vehicles, such as, for example, lidars, proximity sensors or cameras.

To clean windshields or sensors used on motor vehicles, such as lidars, proximity sensors or cameras for example, cleaning methods are known which make it possible to remove a liquid accumulating on an optical surface of the sensor by generating ultrasonic waves and propagating them in or over the optical surface. In particular, document WO 2012/095643 A1 is known, which describes a method for removing raindrops by means of ultrasonic vaporization. The amplitude and frequency of vibration are selected such that raindrops falling on the windshield are vaporized as soon as they enter the vibrating zone of the surface of the windshield. However, in order to obtain vaporization of a drop of liquid, of a pool or of a film, the power levels with which the vibrating zone needs to be vibrated are high, this limiting their practical implementation, in particular in the context of development of autonomous devices. It is moreover well known that vaporization requires energy levels greater than those required to move drops over a medium.

The techniques presented above all have drawbacks related to their integration into smaller surfaces or into proximity with confined surfaces, or even surfaces located behind apertured surfaces making them more difficult to access and clean.

### SUMMARY OF THE INVENTION

One object of the present invention is to provide a new protecting unit in order to address, at least for the most part, the foregoing problems and also afford other advantages.

Another aim of the invention is to facilitate cleaning of an optical surface located behind an apertured surface.

Another aim of the invention is to allow such cleaning while camouflaging the wave transducer and making it less visible.

According to a first aspect of the invention, at least one of the aforementioned objectives is achieved with a unit for protecting an optical surface intended to be associated with an apparatus configured to sense and/or emit radiation through an optical region of interest of the optical surface, the protecting unit comprising:
the optical surface;
an apertured surface secured to the optical surface and placed facing said optical surface, the apertured surface comprising a solid part and at least one aperture formed in the solid part;
at least one transducer of waves that is mechanically coupled to the optical surface and configured to generate a wave propagating through the optical surface and in the direction of and/or into the optical region of interest, the waves generated by the at least one transducer of waves being ultrasonic waves.

In the context of the present invention, the protecting unit allows an apparatus intended to be located behind the optical surface to be protected in order to prevent dust, raindrops or any particulates from reaching the apparatus and hindering its correct operation. In the context of the invention, the protecting unit may be implemented with any apparatus of a motor vehicle, and take any form.

In the context of the present invention, the apertured surface is a mechanical part placed in front of the optical surface, relative to an average direction of propagation of the waves emitted and/or received by the apparatus with which the protecting unit is intended to collaborate. The apertured surface may be formed from one or more parts. The apertured surface is secured to the protecting unit, and hence there is no mobility between the apertured surface and the optical surface. By way of non-limiting examples, the apertured surface may be a mesh, a radiator grille, a piece of sheet metal having at least one aperture, or a bumper part having at least one aperture. According to a particularly advantageous embodiment, the apertured surface comprises a logo of the motor vehicle on which the protecting unit according to the first aspect of the invention is intended to be mounted.

In the context of the present invention, the logo takes the form of a punched part or of a badge the shapes and dimensions of which are representative of a trademark of a motor vehicle or of a model of motor vehicle. In the context of the invention, the logo is preferably a logo embedded on a front face of a motor vehicle, and in particular on a radiator grille of the front face.

Thus, the protecting unit according to the first aspect of the invention makes it possible to combine, in an optimal manner, the logo of a motor vehicle and the presence of apparatuses located behind said logo, the protecting unit thus making it possible to provide a particularly advantageous configuration for the at least one wave transducer, in order to permit optimal operation.

In the context of the present invention, the solid parts of the apertured surface form opaque parts, in particular parts that are opaque to the radiation emitted and/or sensed by the apparatus intended to be located behind. The solid parts are for example parts formed from material, while the at least one aperture of the apertured surface forms a part free of material.

By way of non-limiting example, the apertured surface may be formed from any material, and in particular from a metal or plastic.

In the context of the present invention, the at least one transducer of waves is an electronic chip configured to be able to generate the waves in question. By way of non-limiting example, the at least one transducer of waves (the expressions “transducer of waves” and “wave transducer” are used interchangeably in the present text) is of the type with an electromechanical comb that when biased electrically allows the waves to be generated, such that they propagate in or over the optical surface, in the direction of and/or into the optical regions of interest.

The waves generated by the at least one wave transducer advantageously have a fundamental frequency between 0.1 MHz and 1000 MHz, preferably between 15 MHz and 30 MHz, and for example equal to 20 MHz. In addition or alternatively, the waves generated by the at least one wave transducer advantageously have a surface amplitude—or a deformation amplitude—between 1 nanometer and 500 nanometers.

In the context of the present invention, the waves generated by the at least one wave transducer are ultrasonic waves. More particularly, the waves thus generated are one of the following types:
a surface ultrasonic wave, i.e. a Rayleigh wave, when the optical surface has a thickness greater than the wavelength of the surface ultrasonic wave. Such a surface wave propagates at the surface of the optical surface. A Rayleigh wave is preferred because a maximal proportion of the energy of the wave is concentrated on the top of the optical surface over which it propagates, and may be transmitted to a body, a raindrop for example, resting on the optical surface. In this case, the surface wave propagates over the optical surface to which the at least one transducer is acoustically coupled, or even preferably to which it is fastened;
a ultrasonic bulk wave, or Lamb wave, when the optical surface has a thickness less than the wavelength of the bulk ultrasonic wave. Such a bulk wave propagates through the optical surface and makes it possible to “vibrate” the entire optical surface thus traversed by the bulk wave, i.e. both optical faces located opposite each other and forming the optical surface.

Thus, the protecting unit according to the invention makes it possible to clean the optical surface efficiently by means of propagation of waves in said optical surface, such that a body, a raindrop for example, making contact with the optical surface is accelerated by the wave generated by each at least one wave transducer, with or without the aid of an exterior force, such as gravity or an aerodynamic force for example.

In the context of the present invention, the optical surface may be of any type, and may perform any function in relation to one or more apparatuses intended to emit or sense radiation passing through said optical surface and placed facing said optical surface. By way of non-limiting example, the optical surface may be a constituent optical lens of the one or more apparatuses, through which lens the radiation passes, or even a protective surface positioned facing the one or more optical lenses of the one or more apparatuses. Generally, the optical surface is formed from a material that permits propagation of the ultrasonic waves emitted by the transducer, irrespectively of whether they are surface waves or bulk waves. By way of non-limiting example, and according to one preferred embodiment of the invention, the optical surface is formed from glass in order to promote propagation of such waves. In addition, the optical surface, or at the very least the optical region of interest, is formed from a material that is transparent to the radiation emitted or sensed by the apparatus intended to be associated with the protecting unit according to the first aspect of the invention. In particular, the radiation emitted or sensed by the apparatus propagates in the optical surface, or at the very least in its optical region of interest, by transmission and/or refraction and/or scattering, in such a way that most of the radiation coming from a first side of the optical surface—or at the very least from its optical region of interest—emerges on the other side of the optical surface, i.e. on a second side of the optical surface—or at the very least of its optical region of interest.

In the context of the present invention, the optical region of interest corresponds to a portion of the optical surface located facing the apparatus intended to be associated with the protecting unit and with said optical surface. The optical region of interest corresponds to the portion of the optical surface in which the radiation emitted or sensed by the apparatus passes through the optical surface.

In the context of the present invention, the apparatus intended to be associated with the optical surface of the protecting unit is configured to sense and/or emit radiation. For this purpose, it comprises a radiation sensor and/or emitter. The radiation is for example electromagnetic radiation, a spectrum of which has wavelengths that may be located in the visible and/or invisible spectrum. By way of non-limiting example, the apparatus is preferably selected from an optical remote-sensing apparatus, such as for example a lidar, a camera, a radar, an infrared sensor and an ultrasound range finder.

In particular, in the context of the present invention, integration of such an apparatus behind the logo is particularly confined and restricted. Furthermore, the presence of the at least one aperture in the apertured surface tends to cause an accumulation of particulates on the optical surface located facing said at least one aperture, subsequently making operation of the apparatus intended to be located behind more difficult and less optimal.

Thus, the protecting unit according to the first aspect of the invention makes it possible to facilitate correct operation of the apparatus with which it is intended to be associated, since the optical region of interest of the optical surface through which radiation is sensed or emitted by said apparatus is cleaned by the wave transducer. This advantageous configuration thus makes it possible to reduce interference between bodies that would otherwise have been present on the optical surface, in the optical regions of interest, and the radiation passing through said optical regions of interest.

The protecting unit according to the first aspect of the invention advantageously comprises at least one of the following refinements, the technical features forming these refinements being able to be considered alone or in combination:
the at least one wave transducer is located facing the solid part of the apertured surface. This advantageous configuration makes it possible to mask the at least one wave transducer behind the solid part of the apertured surface. It also makes it possible to avoid cluttering parts of the optical surface located facing the at least one aperture of the apertured surface, which are preferably reserved for future alignment with the apparatus with which the protecting unit is intended to collaborate. More particularly, the alignment between the at least one wave transducer and the solid part of the apertured surface is observed relative to an axis perpendicular to the optical surface located facing;
the at least one wave transducer is securely fastened to the optical surface by any means, and in particular by adhesive bonding;
the at least one wave transducer is intended to be electrically connected to an electrical device by way of at least one electrical wire connected to the at least one wave transducer, the at least one electrical wire lying facing the solid part. The electrical device to which the at least one wave transducer is intended to be electrically connected is for example an electrical power source or a control unit for controlling the at least one transducer. Thus, in the context of the present invention, the at least one electrical wire connecting the at least one wave transducer to the electrical device is a wire for supplying electrical power for biasing the at least one wave transducer and/or a control wire transmitting an electrical signal for controlling operation of the at least one wave transducer. The at least one electrical wire preferably extends along and against the optical surface. In the context of the invention, the at least one electrical wire always lies—as regards the part thereof located facing the apertured surface—facing the solid part of the apertured surface, in order to prevent said at least one electrical wire from being seen. More particularly, the alignment between the at least one electrical wire and the solid part of the apertured surface is observed relative to an axis perpendicular to the optical surface located facing;
in the context of the invention, the at least one electrical wire may be an electrical cable comprising one or more electrical wires braided together and/or placed inside an insulating sheath. Alternatively, each at least one electrical wire may comprise a conductive element housed in an insulating sheath;
the at least one electrical wire is securely fastened to the optical surface. This advantageous configuration makes it possible to prevent the at least one electrical wire from moving during use of the protecting unit according to the first aspect of the invention, or even breaking or becoming damaged during this use. In the context of the present invention, the at least one electrical wire may be securely fastened to the optical surface by any means;
preferably, the at least one electrical wire is adhesively bonded to the optical surface. In the context of the invention, the at least one electrical wire may be adhesively bonded to the optical surface along the entire length of said at least one electrical wire. Alternatively, the at least one electrical wire may be adhesively bonded to the optical surface non-continuously, or even only at its terminations;
according to a first embodiment, the at least one transducer of waves is located on the side of a first face of the optical surface—called the inner face—intended to be located on the side of the apparatus with which the protecting unit is intended to collaborate, opposite a second face of said optical surface—called the outer face—located facing the apertured surface, the waves generated by the at least one transducer of waves being bulk waves. In other words, the at least one apparatus and the at least one wave transducer are located on the same side of the optical surface, relative to a direction of propagation of the radiation emitted by the at least one apparatus. This advantageous configuration thus makes it possible to place the at least one transducer on the side of the at least one apparatus, depending on the available space. Thus, the at least one wave transducer is advantageously configured to generate bulk or Lamb waves in the direction of and/or into the optical region of interest and through the optical surface, so that they reach the face of the optical surface that is sprayed by raindrops and/or particulates and that it is therefore necessary to clean, on the side of the apertured surface;
in the first embodiment, a wavelength of the wave generated by the at least one transducer of waves is greater than or equal to twice a thickness of the optical surface measured in the optical region of interest. This advantageous configuration makes it possible to better dimension both the thickness of the optical surface and the wavelength of the waves generated by the at least one transducer, for optimal operation and optimal cleaning of the optical surface located facing the apertured surface;
according to a second embodiment, the at least one transducer of waves is located on the side of an outer face of the optical surface, located facing the apertured surface, the waves generated by the at least one transducer of waves being Rayleigh waves. In other words, the apparatus and the at least one wave transducer are located on either side of the optical surface, relative to a direction of propagation of the radiation emitted by the at least one apparatus. This advantageous configuration thus makes it possible to place the at least one transducer on the side of the optical surface sprayed by raindrops and/or particulates and that it is therefore necessary to clean. Thus, in this first configuration, the at least one wave transducer is advantageously configured to generate surface waves in the direction of and/or into the optical region of interest;
in this second embodiment, a wavelength of the wave generated by the at least one transducer of waves is less than or equal to one fifth of a thickness of the optical surface measured in the optical region of interest. This advantageous configuration makes it possible to better dimension both the thickness of the optical surface and the wavelength of the waves generated by the at least one transducer, for optimal operation and optimal cleaning of the optical surface located facing the apertured surface;
the protecting unit has a non-zero clearance between the optical surface and the apertured surface, so that the at least one wave transducer is not mechanically coupled to the apertured surface. In other words, the apertured surface is located at a distance from the at least one wave transducer, in order to allow mechanical decoupling between the at least one wave transducer and the apertured surface. This configuration makes it possible to avoid any interference between the at least one transducer and the apertured surface, and promotes propagation of the waves generated by the at least one wave transducer in the optical surface;
a dimension of the clearance, measured in a direction perpendicular to the optical surface, is greater than 100 μm;
advantageously, the protecting unit comprises a cover covering the at least one wave transducer. The cover thus makes it possible to prevent infiltration of water and/or bodies into the at least one wave transducer, and the premature and undesirable malfunction that would then result. The cover is securely fastened to the at least one wave transducer or securely fastened to the optical surface;
the optical surface and the apertured surface are secured to each other. In other words, the optical surface and the apertured surface are held immovably relative to each other;
according to a first variant embodiment, the apertured surface is securely fastened to a holder by fastening tabs that extend through windows formed in the optical surface. In the context of the invention, the optical surface is located in a position intermediate between the holder and the apertured surface, relative to an average direction of propagation of the radiation emitted and/or sensed by the apparatus intended to collaborate with the protecting unit. In other words, the holder is located on the side of a first face of the optical surface—called the inner face—located on the side of the apparatus with which the protecting unit is intended to collaborate, and the apertured surface is then located nearby a second face of said optical surface—called the outer face—located facing the apertured surface and opposite the inner face. In other words, the holder and the apertured surface are located on either side of the optical surface, relative to a direction of propagation of the radiation emitted by the at least one apparatus;
according to a second variant embodiment, the apertured surface is securely fastened to the optical surface by way of fastening tabs secured to the optical surface. In this variant embodiment, the apertured surface is joined directly to the optical surface, without involvement of an intermediate piece forming the holder in the first variant embodiment described above;
in either of the variant embodiments, the fastening tabs may take any form and are configured to allow mechanical coupling to the holder or optical surface to which they are joined;
in either of the variant embodiments, the at least one transducer of waves is placed in a position intermediate between the fastening tabs and the optical region of interest. In other words, in a plane formed by the optical surface, the at least one transducer is located between, on the one hand, a zone of the optical surface through which the fastening tabs pass or to which the fastening tabs are fastened, and, on the other hand, the optical region of interest. Thus, the waves generated by the at least one wave transducer reach the optical region of interest directly, without passing through the zone of the optical surface in which the fastening tabs are located. This advantageous configuration makes it possible to guarantee better operation of the at least one wave transducer and, in the end, better cleaning of the optical surface in the optical region of interest.

According to a second aspect of the invention, provision is made for a detecting assembly comprising:
a protecting unit according to the first aspect of the invention or according to any its refinements;
at least one apparatus configured to sense and/or emit radiation through the optical region of interest of the optical surface and through the at least one aperture of the apertured surface.

In the context of the present invention, the at least one apparatus is located facing the optical surface, at a distance from or against the optical surface, such that the radiation emitted or sensed by said at least one apparatus passes through the optical region of interest of the optical surface. Thus, the optical surface of the protecting unit forms a protective surface for the at least one apparatus.

Furthermore, in the context of the present invention, the at least one apparatus is located facing the at least one aperture of the apertured surface, so as to permit passage of the radiation emitted and/or sensed by said at least one apparatus through said at least one aperture.

The detecting assembly according to the second aspect of the invention advantageously comprises at least one of the following refinements, the technical features forming these refinements being able to be considered on their own or in combination:
the at least one apparatus is secured to the optical surface. In this variant embodiment, the at least one apparatus and the optical surface are rendered immobile with respect to each other. According to a first variant embodiment, the at least one apparatus is securely and directly fastened to the optical surface, the at least one apparatus comprising a fastening member collaborating with the optical surface. By way of non-limiting example, the optical surface may be adhesively bonded to a front portion of the at least one apparatus, or the at least one apparatus may be screwed or snap-fastened to the optical surface. According to a second variant embodiment, the at least one apparatus is securely fastened to a holder to which the optical surface is also securely fastened. In this second variant embodiment, the optical surface and the at least one apparatus comprise fastening members collaborating with the holder, such as fastening screws or fastening clips for example;
according to a first embodiment, the at least one wave transducer is located on a first side of the optical surface opposite a second side on which the at least one apparatus is located. In other words, the at least one apparatus and the at least one wave transducer are located on either side of the optical surface, relative to a direction of propagation of the radiation emitted by the at least one apparatus. This advantageous configuration thus makes it possible to place the at least one transducer on the side of the optical surface sprayed by raindrops and/or particulates and that it is therefore necessary to clean. Thus, in this first configuration, the at least one wave transducer is advantageously configured to generate surface waves in the direction of and/or into the optical region of interest;
according to a second embodiment, the at least one transducer and the at least one apparatus are located on the same side of the optical surface. In other words, the at least one apparatus and the at least one wave transducer are located on the same side of the optical surface, relative to a direction of propagation of the radiation emitted by the at least one apparatus. This advantageous configuration thus makes it possible to place the at least one transducer on the side of the at least one apparatus, depending on the available space. Thus, in this second configuration, the at least one wave transducer is advantageously configured to generate bulk waves in the direction of and/or into the optical region of interest and through the optical surface, so that they reach the face of the optical surface that is sprayed by raindrops and/or particulates and that it is therefore necessary to clean.
According to a third aspect of the invention, a motor vehicle is provided comprising a detecting assembly according to the second aspect of the invention or according to any one of its refinements.
Various embodiments of the invention, incorporating in all of their possible combinations the various optional features described here, are provided.

### BRIEF DESCRIPTION OF DRAWINGS

Other features and advantages of the invention will become more clearly apparent on the one hand from the following description, and on the other hand from a plurality of exemplary embodiments that are given non-limitingly and by way of indication with reference to the appended schematic drawings, in which:

FIG. 1 illustrates a schematic electrical profile view of a first exemplary embodiment of a detecting assembly according to the second aspect of the invention and comprising a protecting unit according to the first aspect of the invention;

FIG. 2 illustrates a schematic electrical profile view of a second exemplary embodiment of a detecting assembly according to the second aspect of the invention and comprising a protecting unit according to the first aspect of the invention;

FIG. 3 illustrates a schematic electrical front view of a third exemplary embodiment of a detecting assembly according to the second aspect of the invention and comprising a protecting unit according to the first aspect of the invention; and

FIG. 4 illustrates a schematic electrical front view of a fourth exemplary embodiment of a detecting assembly according to the second aspect of the invention and comprising a protecting unit according to the first aspect of the invention.

### DETAILED DESCRIPTION OF THE INVENTION

Of course, features, variants and various embodiments of the invention may be combined with one another, in various combinations, provided that they are not mutually incompatible or exclusive. It will be possible, in particular, to imagine variants of the invention that comprise only a selection of the features described below, in isolation from the other features described, if this selection of features is sufficient to confer a technical advantage or to distinguish the invention from the prior art.

In particular, all the variants and all the embodiments described are combinable with one another if there is nothing preventing this combination from a technical perspective.

In the figures, elements that are common to multiple figures retain the same reference.

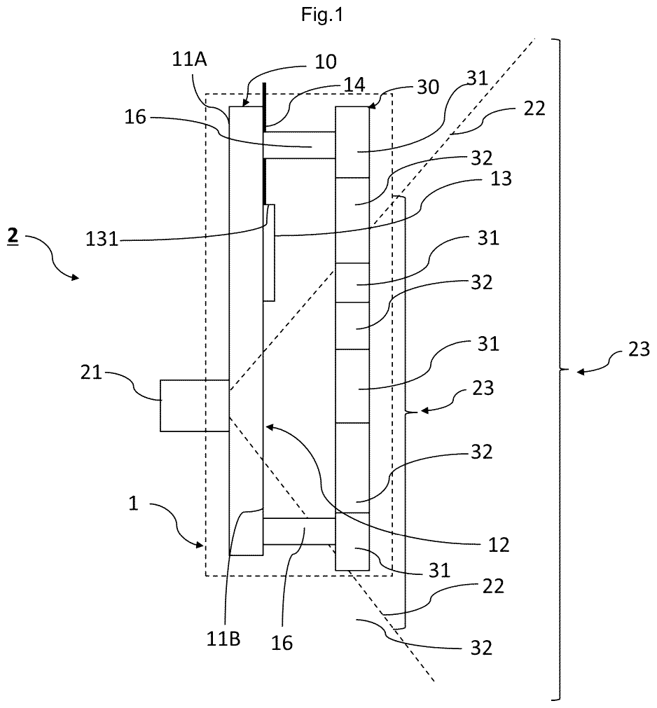

With reference to FIG. 1 to FIG. 4, the invention relates to a unit 1 for protecting an optical surface 10 intended to be associated with an apparatus 21 configured to sense and/or emit radiation 23 through an optical region of interest 12 of the optical surface 10, the protecting unit 1 comprising:
the optical surface 10;
an apertured surface 30 secured to the optical surface 10 and placed facing said optical surface 10, the apertured surface 30 comprising a solid part 31 and at least one aperture 32 formed in the solid part 31;
at least one transducer 13 of waves W that is mechanically coupled to the optical surface 10 and configured to generate a wave W propagating through the optical surface 10 and in the direction of and/or into the optical region of interest 12.

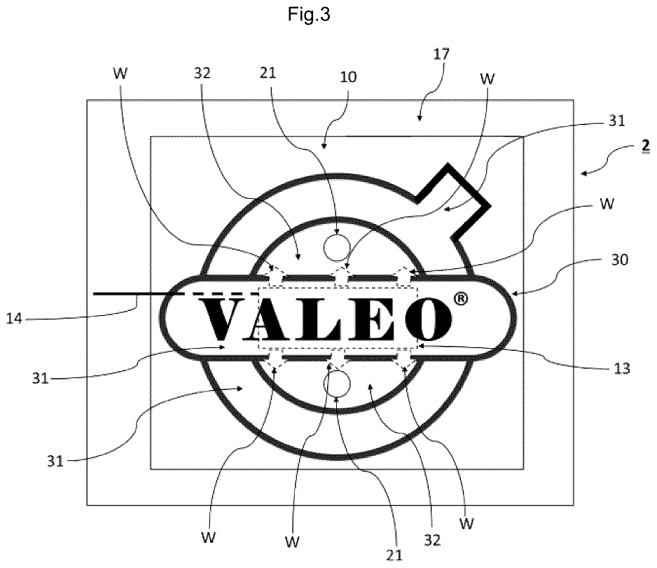

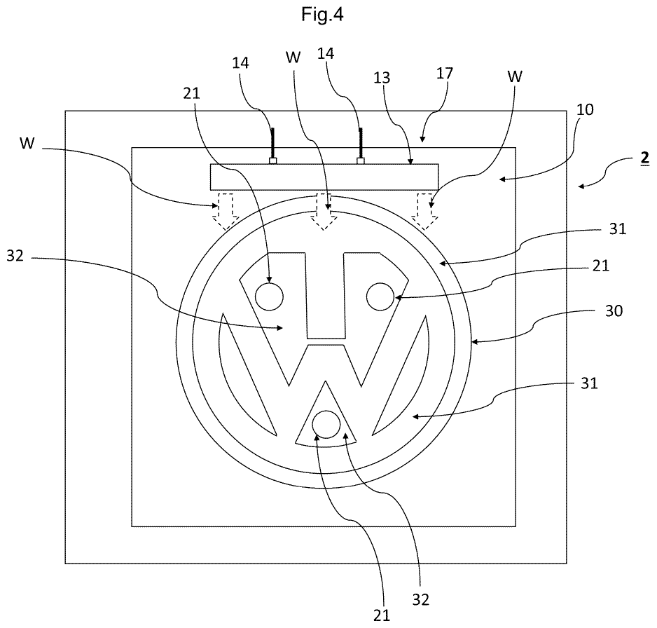

The apertured surface 30 is a mechanical part placed in front of the optical surface 10, relative to an average direction of propagation of the waves W emitted and/or received by the apparatus 21 with which the protecting unit 1 is intended to collaborate. The apertured surface 30 may be formed from one or more parts. The apertured surface 30 is secured to the protecting unit 1, and hence there is no mobility between the apertured surface 30 and the optical surface 10. As may be seen in FIG. 3 and FIG. 4, the apertured surface 30 comprises a logo of the motor vehicle to which the protecting unit 1 is mechanically coupled.

The solid parts 31 of the apertured surface 30 form parts that are opaque to the radiation 23 emitted and/or sensed by the apparatus 21 intended to be located behind the optical surface 10. The solid parts 31 are for example parts formed from material, while the at least one aperture 32 of the apertured surface 30 forms a part free of material.

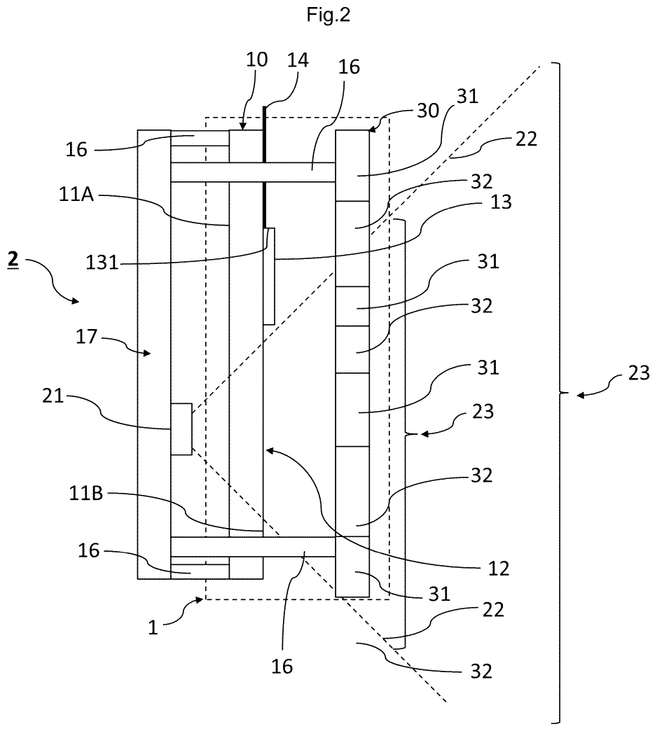

As may be seen in FIG. 1 and FIG. 2, there is a non-zero clearance between the optical surface 10 and the apertured surface 30, so that the transducer 13 of waves W is not mechanically coupled to the apertured surface 30. In other words, the apertured surface 30 is located at a distance from the transducer 13 of waves W, in order to allow mechanical decoupling between the transducer 13 of waves W and the apertured surface 30.

In the exemplary embodiment illustrated in FIG. 1, the apertured surface 30 is securely fastened to the optical surface 10 by way of fastening tabs 16 secured to the optical surface 10.

In the exemplary embodiment illustrated in FIG. 2, the apertured surface 30 is securely fastened to a holder 17 by fastening tabs 16 that extend through windows formed in the optical surface 10. Thus, the holder 17 is located on the side of a first face 11A of the optical surface 10—called the inner face—located on the side of the apparatus 21 with which the protecting unit 1 is intended to collaborate, and the apertured surface 30 is then located nearby a second face 11B of said optical surface 10—called the outer face—located facing the apertured surface 30 and opposite the inner face. In other words, the holder 17 and the apertured surface 30 are located on either side of the optical surface 10, relative to a direction of propagation of the radiation 23 emitted by the apparatus 21.

In order not to hinder propagation of the waves W over or through the optical surface 10, and as shown in FIG. 1 to FIG. 3, the transducer 13 of waves W is placed in a position intermediate between the fastening tabs 16 and the optical region of interest 12. In other words, on the second face 11B of the optical surface 10, the transducer 13 is located between, on the one hand, a zone of the optical surface 10 through or to which the fastening tabs 16 pass or are fastened, and on the other hand, an optical region of interest 12 formed by the region of the optical surface 10 in which the radiation 23 emitted and/or sensed by the apparatus 21 is transmitted through said optical surface 10.

In the exemplary embodiment illustrated in FIG. 1 to FIG. 4, a detecting assembly 2 is also illustrated, this detecting assembly comprising:
a protecting unit 1;
at least one apparatus 21 configured to sense and/or emit radiation 23 through the optical region of interest 12 of the optical surface 10 and through the at least one aperture 32 of the apertured surface 30.

Thus, as may be seen in FIG. 3 and FIG. 4, each apparatus 21 collaborating with the protecting unit 1 and its optical surface 10 is located facing the at least one aperture 32 of the apertured surface 30, in order to be able to efficiently sense and/or emit the radiation 23 through the optical surface 10 and the apertured surface 30 simultaneously.

Each apparatus 21 is located facing the optical surface 10, at a distance from or against the optical surface 10, such that the radiation 23 emitted or sensed by said at least one apparatus 21 passes through the optical region of interest 12 of the optical surface 10.

Each apparatus 21 is secured to the optical surface 10, so that each apparatus 21 and the optical surface 10 are rendered immobile with respect to each other.

In the example illustrated in FIG. 1, the apparatus 21 is securely fastened directly to the optical surface 10, for example by adhesive bonding, screwing or snap-fastening.

In the example illustrated in FIG. 2, the apparatus 21 is securely fastened to a holder 17 to which the optical surface 10 is also securely fastened.

The one or more transducers 13 associated with the optical surface 10 are acoustically coupled to said optical surface 10—and preferably mechanically coupled thereto—so as to be able to generate waves W which propagate over the second face 11B of the optical surface 10—in particular when the transducer 13 of waves W is located on or on the side of the second face 11B—or through the optical surface 10, in particular when the transducer 13 of waves W is located on or on the side of the first face 11A of the optical surface 10.

In the example illustrated in FIG. 4, the transducer 13 of waves W is located facing the solid part 31 of the apertured surface 30 in order to hide it behind the solid part 31 of the apertured surface 30. In this exemplary embodiment, an electrical wire 14 connected to each transducer 13 of waves W lies facing the solid part 31 of the apertured surface 30 so as not to be visible when the apertured surface 30 is looked at from the front, as in FIG. 4. Thus, the electrical wire 14 extends in the direction of a lateral edge of the optical surface 10 behind and facing the solid part 31 of the apertured surface 30.

In the example illustrated in FIG. 3, the transducer 13 of waves W is misaligned with respect to the apertured surface 30 and/or with respect to its solid part 31. More particularly, in this exemplary embodiment, the transducer 13 of waves W is located on top of the apertured surface 30. In this exemplary embodiment, an electrical wire 14 connected to each transducer 13 of waves W extends away from the apertured surface 30 and/or in the direction of a lateral edge of the optical surface 10.

Each transducer 13 of waves W is securely fastened to the optical surface 10 by any means, and in particular by adhesive bonding.

Each electrical wire 14 is securely fastened to the optical surface 10 by any means, and in particular by adhesive bonding.

In the exemplary embodiment illustrated in FIG. 1 and FIG. 2, the transducer 13 of waves W is located on the second face 11B of the optical surface 10, opposite the first face 11A of said optical surface 10 and nearby which the apparatus 21 is located. This configuration thus makes it possible to clean the second face 11B located facing the apertured surface 30 more efficiently.

In summary, the invention relates to a unit 1 for protecting an apparatus 21 and to a detecting assembly 2 associating the apparatus 21 emitting or sensing radiation 23 through a region of interest of an optical surface 10 of the protecting unit 1. The protecting unit 1 further comprises at least one transducer 13 of waves W configured to generate an acoustic wave W on or in the optical surface 10 in order to clean the optical region of interest 12. According to the invention, the protecting unit 1 further comprises an apertured surface 30 located facing the optical surface 10, the apertured surface 30 comprising a solid part 31 and at least one aperture 32 through which the radiation 23 emitted and/or sensed by the apparatus 21 is able to pass.

Of course, the invention is not limited to the examples which have just been described, and many modifications may be made to these examples without departing from the scope of the invention. In particular, the various features, forms, variants and embodiments of the invention may be combined with one another, in various combinations, as long as they are not mutually incompatible or exclusive. In particular, all the variants and embodiments described above are combinable with one another.

1. A unit for protecting an optical surface intended to be associated with an apparatus configured to sense and/or emit radiation through an optical region of interest of the optical surface, the protecting unit comprising:
the optical surface;
an apertured surface secured to the optical surface and placed facing the optical surface, the apertured surface includes a solid part and at least one aperture formed in the solid part;
at least one transducer of waves that is mechanically coupled to the optical surface and configured to generate wave propagating through the optical surface and in the direction of and/or into the optical region of interest, the waves generated by the at least one transducer of waves being ultrasonic waves.

2. The protecting unit as claimed in claim 1, wherein the apertured surface is a mesh, a radiator grille, a piece of sheet metal having at least one aperture or a bumper part having at least one aperture.

3. The protecting unit as claimed in claim 1, wherein the at least one transducer of waves is located facing the solid part of the apertured surface.

4. The protecting unit as claimed in claim 1, wherein the at least one transducer waves is located on the side of a first face of the optical surface—called the inner face—intended to be located on the side of the apparatus with which the protecting unit is intended to collaborate, opposite a second face of the optical surface—called the outer face—located facing the apertured surface, the waves generated by the at least one transducer of waves being bulk waves.

5. The protecting unit as claimed in claim 4, wherein a wavelength of the wave generated by the at least one transducer of waves is greater than or equal to twice a thickness of the optical surface measured in the optical region of interest.

6. The protecting unit as claimed in claim 1, wherein the at least one transducer waves is located on the side of an outer face of the optical surface, located facing the apertured surface, the waves generated by the at least one transducer of waves being Rayleigh waves.

7. The protecting unit as claimed in claim 6, wherein a wavelength of the wave generated by the at least one transducer waves is less than or equal to one fifth of a thickness of the optical surface measured in the optical region of interest.

8. The protecting unit as claimed in claim 1, wherein the apertured surface is securely fastened to a holder by fastening tabs that extend through windows formed in the optical surface.

9. The protecting unit as claimed in claim 1, wherein the apertured surface is securely fastened to the optical surface by way of fastening tabs secured to the optical surface.

10. The protecting unit as claimed in claim 8, wherein the at least one transducer of waves is placed in a position intermediate between the fastening tabs and the optical region of interest.

11. A detecting assembly comprising:
a protecting unit, the protecting unit includes an optical surface, an apertured surface secured to the optical surface and placed facing the optical surface, the apertured surface includes a solid part and at least one aperture formed in the solid part, and at least one transducer of waves that is mechanically coupled to the optical surface and configured to generate a wave propagating through the optical surface and in the direction of and/or into the optical region of interest, the waves generated by the at least one transducer of waves being ultrasonic waves;
at least one apparatus configured to sense and/or emit radiation through the optical region of interest of the optical surface and through the at least one aperture of the apertured surface.
